(19) United States
(12) Patent Application Publication
(10) Pub. No.: US 2016/0307097 A1
(43) Pub. Date: Oct. 20, 2016

(54) Method and Apparatus for Automatically Replying to Information

(71) Applicant: Huawei Technologies Co., Ltd., Shenzhen (CN)

(72) Inventors: Zhengdong Lu, Hong Kong (HK); Hang Li, Hong Kong (HK)

(21) Appl. No.: 15/198,879

(22) Filed: Jun. 30, 2016

Related U.S. Application Data
(63) Continuation of application No. PCT/CN2014/082491, filed on Jul. 18, 2014.

(30) Foreign Application Priority Data
Dec. 31, 2013 (CN) 201310754249.7

(51) Int. Cl. G06N 3/08; H04L 12/58

(52) U.S. Cl. CPC G06N 3/08; H04L 51/02; H04L 51/16

(57) ABSTRACT

The present disclosure includes acquiring a keyword of information to be replied to, as a first feature, and acquiring a keyword of a pending reply in a pending reply set as a second feature, calculating, according to a correlation between the first feature and the second feature, a match between the information to be replied to and the pending reply, where the correlation between the first feature and the second feature is obtained through multiple trainings according to an original text and a reply to the original text that are acquired from a corpus environment, where the corpus environment includes a microblog, a forum, and a post bar, repeating the foregoing steps, until matches between the information to be replied to and all pending replies are obtained, and selecting a best matched pending reply as a reply to the information to be replied to.

### CROSS-REFERENCE TO RELATED APPLICATIONS

This application is a continuation of International Application No. PCT/CN2014/082491, filed on Jul. 18, 2014, which claims priority to Chinese Patent Application No. 201310754249.7, filed on Dec. 31, 2013, both of which are hereby incorporated by reference in their entireties.

### TECHNICAL FIELD

The present disclosure relates to artificial intelligence, and in particular, to a method and an apparatus for automatically replying to information.

### BACKGROUND

Bringing better use experience to a user is an important objective of a terminal manufacturer, and is also a magic weapon for the terminal manufacturer to stand out. In the prior art, after a user receives a short message service (SMS) message, to reply to the SMS message, the user can only input words one by one manually, or in a QQ™ chat, after receiving a piece of information to be replied to that is sent by a peer, a user can only input words one by one in a reply box manually, which is quite low in efficiency, and makes the user feel that the use is quite inconvenient.

To solve the foregoing problem, the prior art provides a method, where some common replies may be preset, for example, “I am in a meeting. I will contact you after a while.” When encountering corresponding scenarios, the user may select these preset replies to achieve a quick input objective.

However, these practices are intended for only specific scenarios. In an open field, content of received information to be replied to that is sent by peers may vary greatly, and cannot be processed in the prior art.

### SUMMARY

The present disclosure provides a method and an apparatus for automatically replying to information, which can automatically reply to information sent by a peer and greatly improve reply efficiency in an open field.

A first aspect of the present disclosure provides a method for acquiring a feature correlation, including the following steps acquiring, from a corpus environment, an original text and an eligible reply to the original text, where the corpus environment includes a microblog, a forum, and a post bar, and the eligible reply is a reply complying with a set condition, acquiring a keyword of the original text as a first feature, and acquiring a keyword of the eligible reply as a second feature, and training a neural network model using the first feature and the second feature, to obtain a correlation between the first feature and the second feature.

With reference to the first aspect, in a first possible implementation manner of the first aspect of the present disclosure, the step of acquiring, from a corpus environment, an original text and an eligible reply to the original text, includes acquiring, from the corpus environment, the original text and a reply to the original text, and cleaning the reply to the original text according to the set condition to obtain the eligible reply to the original text, where the set condition includes that a count of words exceeds 5, and that there is no attachment, and that the reply is within the first one hundred replies sorted in reply order.

A second aspect of the present disclosure provides an apparatus for acquiring a feature correlation, including a corpus acquiring module, a feature acquiring module, and a training module, where the corpus acquiring module is configured to acquire, from a corpus environment, an original text and an eligible reply to the original text, where the corpus environment includes a microblog, a forum, and a post bar, and the eligible reply is a reply complying with a set condition, where the corpus acquiring module sends, to the feature acquiring module, the acquired original text and eligible reply to the original text, the feature acquiring module is configured to receive the acquired original text and eligible reply to the original text, acquire a keyword of the original text as a first feature, and acquire a keyword of the eligible reply as a second feature, where the feature acquiring module sends the first feature and the second feature to the training module, and the training module is configured to receive the first feature and the second feature, and train a neural network model using the first feature and the second feature, to obtain a correlation between the first feature and the second feature.

With reference to the second aspect, in a first possible implementation manner of the second aspect of the present disclosure, the corpus acquiring module includes a corpus acquiring unit and a cleaning unit, where the corpus acquiring unit is configured to acquire, from the corpus environment, the original text and a reply to the original text, where the corpus acquiring unit sends, to the cleaning unit, the reply to the original text, and the cleaning unit is configured to receive the reply to the original text, and clean the reply to the original text according to the set condition to obtain the eligible reply to the original text, where the set condition includes that a count of words exceeds 5, and that there is no attachment, and that the reply is within the first one hundred replies sorted in reply order.

A third aspect of the present disclosure provides a server, including a processor, an input device, and an output device, where the input device is configured to input data, the processor is configured to acquire, from a corpus environment, an original text and an eligible reply to the original text, where the corpus environment includes a microblog, a forum, and a post bar, and the eligible reply is a reply complying with a set condition, acquire a keyword of the original text as a first feature, and acquire a keyword of the eligible reply as a second feature, and train a neural network model using the first feature and the second feature, to obtain a correlation between the first feature and the second feature, and the output device is configured to output data.

With reference to the third aspect, in a first possible implementation manner of the third aspect of the present disclosure, the processor is further configured to acquire, from the corpus environment, the original text and a reply to the original text, and clean the reply to the original text according to the set condition to obtain the eligible reply to the original text, where the set condition includes that a count of words exceeds 5, and that there is no attachment, and that the reply is within the first one hundred replies sorted in reply order.

A fourth aspect of the present disclosure provides a method for automatically replying to information, including the following steps receiving information to be replied to, acquiring a keyword of the information to be replied to, as a first feature, and acquiring a keyword of a pending reply in a pending reply set as a second feature, calculating, according to a correlation between the first feature and the second feature, a match between the information to be replied to and the pending reply, where the correlation between the first feature and the second feature is obtained through multiple training s according to an original text and a reply to the original text that are acquired from a corpus environment, where the corpus environment includes a microblog, a forum, and a post bar, repeating the steps of acquiring a first feature and a second feature and calculating a match, until matches between the information to be replied to and all pending replies are obtained, and selecting a best matched pending reply as a reply to the information to be replied to, to implement an automatic reply to the information to be replied to.

With reference to the fourth aspect, in a first possible implementation manner of the fourth aspect of the present disclosure, the method further includes acquiring, from the corpus environment, the original text and an eligible reply to the original text, where the corpus environment includes a microblog, a forum, and a post bar, and the eligible reply is a reply complying with a set condition, acquiring a keyword of the original text as the first feature, and acquiring a keyword of the eligible reply as the second feature, and training a neural network model using the first feature and the second feature, to obtain the correlation between the first feature and the second feature.

With reference to the fourth aspect, in a second possible implementation manner of the fourth aspect of the present disclosure, after the selecting a best matched pending reply as a reply to the information to be replied to, the method further includes performing customized processing on the best matched pending reply to obtain a customized reply.

With reference to the fourth aspect, in a third possible implementation manner of the fourth aspect of the present disclosure, the step of acquiring a keyword of a pending reply in a pending reply set as a second feature includes quickly retrieving replies in a reply database to obtain the pending reply set, and acquiring the keyword of the pending reply in the pending reply set as the second feature.

With reference to the fourth aspect, in a fourth possible implementation manner of the fourth aspect of the present disclosure, the step of calculating, according to a correlation between the first feature and the second feature, a match between the information to be replied to and the pending reply, includes calculating, according to

$$P = {\sum }_{i ∈ N} {a}_{i} {x}_{i} ,$$

the match between me information to be replied to and the pending reply, where P is the match, N is an association set of the first feature and the second feature, i is an element in N, aᵢ is a weight, and xᵢ is the correlation between the first feature and the second feature.

A fifth aspect of the present disclosure provides an apparatus for automatically replying to information, including a receiving module, a feature acquiring module, a match calculating module, and a selecting module, where the receiving module is configured to receive information to be replied to, where the receiving module sends, to the feature acquiring module, the information to be replied to, the feature acquiring module is configured to receive the information to be replied to, acquire a keyword of the information to be replied to, as a first feature, and acquire a keyword of a pending reply in a pending reply set as a second feature, where the feature acquiring module sends the first feature and the second feature to the match calculating module, the match calculating module is configured to receive the first feature and the second feature, and calculate, according to a correlation between the first feature and the second feature, a match between the information to be replied to and the pending reply, until matches between the information to be replied to and all pending replies are obtained, where the correlation between the first feature and the second feature is obtained through multiple trainings according to an original text and a reply to the original text that are acquired from a corpus environment, where the corpus environment includes a microblog, a forum, and a post bar, where the match calculating module sends the matches to the selecting module, and the selecting module is configured to receive the match, and select a best matched pending reply as a reply to the information to be replied to, to implement an automatic reply to the information to be replied to.

With reference to the fifth aspect, in a first possible implementation manner of the fifth aspect of the present disclosure, the apparatus further includes a corpus acquiring module, a feature acquiring module, and a training module, where the corpus acquiring module is configured to acquire, from the corpus environment, the original text and an eligible reply to the original text, where the corpus environment includes a microblog, a forum, and a post bar, and the eligible reply is a reply complying with a set condition, where the corpus acquiring module sends, to the feature acquiring module, the acquired original text and eligible reply to the original text, the feature acquiring module is configured to receive the acquired original text and eligible reply to the original text, acquire a keyword of the original text as the first feature, and acquire a keyword of the eligible reply as the second feature, where the feature acquiring module sends the first feature and the second feature to the training module, and the training module is configured to receive the first feature and the second feature, and train a neural network model using the first feature and the second feature, to obtain the correlation between the first feature and the second feature.

With reference to the fifth aspect, in a second possible implementation manner of the fifth aspect of the present disclosure, the apparatus further includes a customized processing module, where the customized processing module is configured to perform customized processing on the best matched pending reply to obtain a customized reply.

With reference to the fifth aspect, in a third possible implementation manner of the fifth aspect of the present disclosure, the feature acquiring module includes a quick retrieving unit and a feature acquiring unit, where the quick retrieving unit is configured to quickly retrieve replies in a reply database to obtain the pending reply set, where the quick retrieving unit sends the pending reply set to the feature acquiring unit, and the feature acquiring unit is configured to receive the pending reply set, and acquire the keyword of the pending reply in the pending reply set as the second feature.

With reference to the fifth aspect, in a fourth possible implementation manner of the fifth aspect of the present disclosure, the match calculating module is configured to calculate, according to

$$P = {\sum }_{i ∈ N} {a}_{i} {x}_{i} ,$$

the match between the information to be replied to and the pending reply, where P is the match, N is an association set of the first feature and the second feature, i is an element in N, aᵢ is a weight, and xᵢ is the correlation between the first feature and the second feature.

A sixth aspect of the present disclosure provides a terminal, including a receiver, a processor, and a transmitter, where the receiver is configured to receive information to be replied to, the processor is configured to acquire a keyword of the information to be replied to, as a first feature, and acquire a keyword of a pending reply in a pending reply set as a second feature, calculate, according to a correlation between the first feature and the second feature, a match between the information to be replied to and the pending reply, until matches between the information to be replied to and all pending replies are obtained, where the correlation between the first feature and the second feature is obtained through multiple trainings according to an original text and a reply to the original text that are acquired from a corpus environment, where the corpus environment includes a microblog, a forum, and a post bar, and select a best matched pending reply as reply information to the information to be replied to, to implement an automatic reply to the information to be replied to, and the transmitter is configured to send the reply information.

With reference to the sixth aspect, in a first possible implementation manner of the sixth aspect of the present disclosure, the processor is further configured acquire, from the corpus environment, the original text and an eligible reply to the original text, where the corpus environment includes a microblog, a forum, and a post bar, and the eligible reply is a reply complying with a set condition, acquire a keyword of the original text as the first feature, and acquire a keyword of the eligible reply as the second feature, and train a neural network model using the first feature and the second feature, to obtain the correlation between the first feature and the second feature.

With reference to the sixth aspect, in a second possible implementation manner of the sixth aspect of the present disclosure, the processor is further configured to perform customized processing on the best matched pending reply to obtain a customized reply.

With reference to the sixth aspect, in a third possible implementation manner of the sixth aspect of the present disclosure, the processor is further configured to quickly retrieve replies in a reply database to obtain the pending reply set, and acquire the keyword of the pending reply in the pending reply set as the second feature.

With reference to the sixth aspect, in a fourth possible implementation manner of the sixth aspect of the present disclosure, the processor is further configured to calculate, according to

$$P = {\sum }_{i ∈ N} {a}_{i} {x}_{i} ,$$

the match between the information to be replied to and the pending reply, where P is the match, N is an association set of the first feature and the second feature, i is an element in N, aᵢ is a weight, and xᵢ is the correlation between the first feature and the second feature.

According to the foregoing solutions, a reply database can be obtained from a corpus environment, and a training is performed using an original text and a reply to the original text that are extracted from the corpus environment, and therefore a correlation between a first feature and a second feature is obtained, a match between information to be replied to and a pending reply is calculated, and further, a best matched pending reply is selected as a reply to the information to be replied to, so that user reply efficiency can be improved, and user experience is improved.

### BRIEF DESCRIPTION OF DRAWINGS

FIG. 1 is a flowchart of an implementation manner of a method for acquiring a feature correlation according to the present disclosure.

FIG. 2 is a flowchart of an implementation manner of a method for automatically replying to information according to the present disclosure.

FIG. 3 is a schematic structural diagram of an implementation manner of an apparatus for acquiring a feature correlation according to the present disclosure.

FIG. 4 is a schematic structural diagram of an implementation manner of an apparatus for automatically replying to information according to the present disclosure.

FIG. 5 is a schematic structural diagram of an implementation manner of a terminal according to the present disclosure.

FIG. 6 is a schematic structural diagram of another implementation manner of a terminal according to the present disclosure.

### DESCRIPTION OF EMBODIMENTS

In the following description, to illustrate rather than limit, specific details such as a particular system structure, an interface, and a technology are provided to make a thorough understanding of the present disclosure. However, a person skilled in the art should know that the present disclosure may be practiced in other embodiments without these specific details. In other cases, detailed descriptions of well-known apparatuses, circuits, and methods are omitted, so that the present disclosure is described without being obscured by unnecessary details.

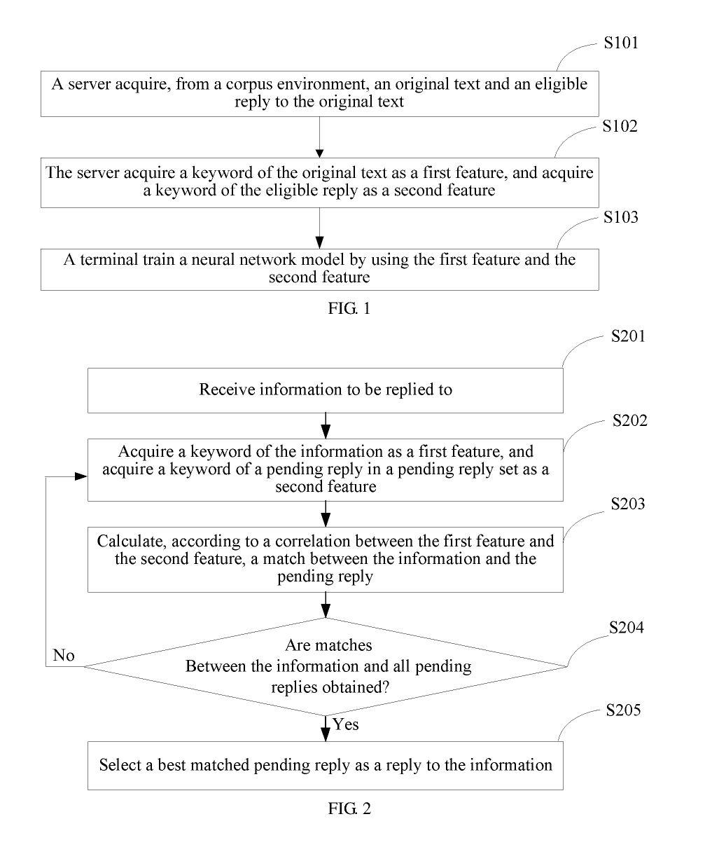

FIG. 1 is a flowchart of an implementation manner of a method for acquiring a feature correlation according to the present disclosure. The method for acquiring a feature correlation in this implementation manner includes the following steps:

S101. A server acquires, from a corpus environment, an original text and an eligible reply to the original text, where the corpus environment includes a microblog, a forum, and a post bar.

A corpus environment, such as a microblog, a forum, and a post bar, includes a large quantity of original texts and replies to the original texts, which cover various scenarios of life and can be used as good materials for making automatic replies. Therefore, an original text and a reply to the original text are acquired from the corpus environment. For example:

original text in a microblog: “Congratulations to @*** on his dissertation published in ACL 2012. This is his second dissertation in ACL”,

reply 1: “Heartiest congratulations to dear alumnus”,

original text in a microblog: “An important conference ICWSM2013 on social media has disclosed some data sets of social media, including Twitter®, Facebook®, Youtube®, and the like”,

reply 1: “Wow, how timely it is! I am looking for such big data sets. Thanks for sharing”, and

reply 2: “Hey, thanks a lot”.

The original text and the reply to the original text are acquired from the corpus environment, and the reply to the original text is cleaned according to a set condition for an eligible reply. The set condition may be set according to an actual use requirement. For example, replies in which a count of words does not exceed 5, those including an attachment, and those after the first one hundred replies sorted in reply order are deleted, or replies of a particular user are deleted, and the remaining replies are eligible replies to the original text.

S102. The server acquires a keyword of the original text as a first feature, and acquires a keyword of the eligible reply as a second feature.

The keyword is extracted from the original text as the first feature. For example, when the original text is “Congratulations to @*** on his dissertation published in ACL 2012. This is his second dissertation in ACL”, the first features “dissertation” and “published” may be extracted.

The keyword is extracted from the eligible reply as the second feature. For example, when the eligible reply is “Heartiest congratulations to dear alumnus”, the second features “heartiest” and “congratulations” may be extracted.

S103. A terminal trains a neural network model using the first feature and the second feature, to obtain a correlation between the first feature and the second feature.

The neural network model is trained using the first feature and the second feature. For example, the first features “dissertation” and “published” and the second feature “congratulations” are input to the neural network model, and a training is performed. When there are enough original texts and eligible replies to the original texts, correlations between features extracted from the original texts and features extracted from the eligible replies may be determined, and stored locally as a model, meanwhile, the eligible replies or a part of the eligible replies are also stored in a local reply database.

According to the foregoing solution, a reply database can be obtained from a corpus environment, and a training is performed using an original text and a reply to the original text that are extracted from the corpus environment, and therefore a correlation between a first feature and a second feature is obtained.

FIG. 2 is a flowchart of an implementation manner of a method for automatically replying to information according to the present disclosure. The method for automatically replying to information in this implementation manner includes the following steps:

S201. A terminal receives information to be replied to.

S202. The terminal acquires a keyword of the information to be replied to, as a first feature, and acquires a keyword of a pending reply in a pending reply set as a second feature.

A user may receive, using QQ™, SMS, WeChat™, and the like, information to be replied to. For example, when the information to be replied to that is received by the user is “My dissertation has been published in ACL 2012”, keywords “dissertation”, “published”, and the like of the information to be replied to are acquired as first features.

In the implementation manner shown in FIG. 1, eligible replies or a part of eligible replies have been stored in a reply database. However, because a quantity of replies in the reply database is huge, after the user receives the information to be replied to, a locality sensitive hashing (LSH) or inverted indexing technology or the like is used to quickly retrieve replies in the reply database to obtain a small pending reply set. Then a pending reply is selected from the pending reply set, and a feature of the pending reply is extracted as a second feature. For example, if the selected pending reply is “Heartiest congratulations to you”, the extracted second features are “heartiest” and “congratulations”. Therefore, in this case, an association set of the first features and the second features is {(dissertation, heartiest), (dissertation, congratulations), (published, heartiest), and (published, congratulations)}.

S203. The terminal calculates, according to a correlation between the first feature and the second feature, a match between the information to be replied to and the pending reply.

In the embodiment shown in FIG. 1, a correlation between a first feature and a second feature has been obtained through multiple trainings according to an original text and a reply to the original text that are acquired from a corpus environment, where the corpus environment includes a microblog, a forum, and a post bar. Therefore, a correlation between the first feature “dissertation” and the second feature “heartiest”, a correlation between the first feature “dissertation” and the second feature “congratulations”, a correlation between the first feature “published” and the second feature “heartiest”, and a correlation between the first feature “published” and the second feature “congratulations” in the association set of the first features and the second features may be known. The match between the information to be replied to and the pending reply is calculated according to the correlation between the first feature and the second feature. The match between the information to be replied to and the pending reply is calculated according to

$$P = {\sum }_{i ∈ N} {a}_{i} {x}_{i} ,$$

where P is the match, N is the association set of the first feature and the second feature, i is an element in N, aᵢ is a weight, and xᵢ is a correlation between elements in the association set of the first feature and the second feature. For example, it may be assumed that the match between the information to be replied to and the pending reply is equal to the correlation between the first feature “dissertation” and the second feature “heartiest”*a first weight+the correlation between the first feature “dissertation” and the second feature “congratulations”*a second weight+the correlation between the first feature “published” and the second feature “heartiest”*a third weight+the correlation between the first feature “published” and the second feature “congratulations”*a fourth weight. Certainly, in other implementation manners, the match between the information to be replied to and the pending reply may also be used using other functions, which are not illustrated exhaustively herein.

S204. The terminal determines whether matches between the information to be replied to and all pending replies are obtained. If the matches between the information to be replied to and all the pending replies are not obtained, the terminal acquires a next pending reply (for example, the next pending reply is “Good job”), and returns to step S202 to acquire a keyword of the next pending reply in the pending reply set as a second feature and calculate a match between the information to be replied to and the next pending reply, until the matches between the information to be replied to and all the pending replies are obtained. If the matches between the information to be replied to and all the pending replies are obtained, step S205 is performed.

S205. The terminal selects a best matched pending reply as a reply to the information to be replied to, to implement an automatic reply to the information to be replied to.

The matches between the information to be replied to and all the pending replies are sorted, and the best matched pending reply is selected as the reply to the information to be replied to, so that an automatic reply to the information to be replied to is implemented.

According to the foregoing solution, a match between information to be replied to and a pending reply can be calculated according to a correlation between a first feature and a second feature, so that a best matched pending reply is selected as a reply to the information to be replied to, and therefore user reply efficiency can be improved.

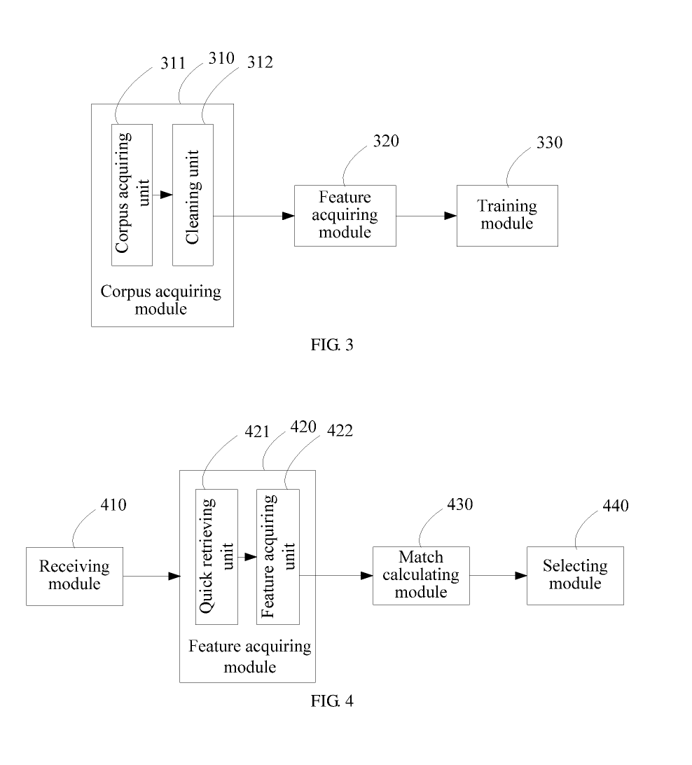

FIG. 3 is a schematic structural diagram of an implementation manner of an apparatus for acquiring a feature correlation according to the present disclosure. The apparatus for acquiring a feature correlation in this implementation manner includes a corpus acquiring module 310, a feature acquiring module 320, and a training module 330. The corpus acquiring module 310 includes a corpus acquiring unit 311 and a cleaning unit 312.

The corpus acquiring module 310 is configured to acquire, from a corpus environment, an original text and an eligible reply to the original text, where the corpus environment includes a microblog, a forum, and a post bar.

The corpus acquiring unit 311 is configured to acquire, from the corpus environment, the original text and a reply to the original text.

For example, a corpus environment, such as a microblog, a forum, and a post bar, includes a large quantity of original texts and replies to the original texts, which cover various scenarios of life and can be used as good materials for making automatic replies. Therefore, the corpus acquiring unit 311 acquires, from the corpus environment, an original text and a reply to the original text. For example:

original text in a microblog: “Congratulations to @*** on his dissertation published in ACL 2012. This is his second dissertation in ACL”,

reply 1: “Heartiest congratulations to dear alumnus”,

original text in a microblog: “An important conference ICWSM2013 on social media has disclosed some data sets of social media, including Twitter, Facebook, Youtube, and the like, http://t.cn/zQwu2rs”,

reply 1: “Wow, how timely it is! I am looking for such big data sets. Thanks for sharing”, and

reply 2: “Hey, thanks a lot”.

The corpus acquiring unit 311 sends, to the cleaning unit 312, the reply to the original text.

The cleaning unit 312 is configured to receive the reply to the original text, and clean the reply to the original text according to a set condition for an eligible reply to obtain the eligible reply to the original text, where the set condition may be set according to an actual use requirement. For example, the set condition for the eligible reply includes that a count of words exceeds 5, and that there is no attachment, and that the reply is within the first one hundred replies sorted in reply order. Therefore, the cleaning unit 312 deletes replies in which a count of words does not exceed 5, those including an attachment, and those after the first one hundred replies, or deletes replies of a particular user, and the remaining replies are eligible replies to the original text.

The corpus acquiring module 310 sends, to the feature acquiring module 320, the acquired original text and eligible reply to the original text.

The feature acquiring module 320 is configured to receive the acquired original text and eligible reply to the original text, acquire a keyword of the original text as a first feature, and acquire a keyword of the eligible reply as a second feature.

For example, the feature acquiring module 320 extracts the keyword from the original text as the first feature. For example, when the original text is “Congratulations to @*** on his dissertation published in ACL 2012. This is his second dissertation in ACL”, the first features “dissertation” and “published” may be extracted.

The feature acquiring module 320 extracts the keyword from the eligible reply as the second feature. For example, when the eligible reply is “Heartiest congratulations to dear alumnus”, the second features “heartiest” and “congratulations” may be extracted.

The feature acquiring module 320 sends the first feature and the second feature to the training module 330.

The training module 330 is configured to receive the first feature and the second feature, and train a neural network model using the first feature and the second feature, to obtain a correlation between the first feature and the second feature.

For example, the neural network model is trained using the first feature and the second feature. For example, the first features “dissertation” and “published” and the second feature “congratulations” are input to the neural network model, and a training is performed. When there are enough original texts and eligible replies to the original texts, correlations between features extracted from the original texts and features extracted from the eligible replies may be determined, and stored locally as a model, meanwhile, the eligible replies or a part of the eligible replies are also stored in a local reply database.

According to the foregoing solution, a reply database can be obtained from a corpus environment, and a training is performed using an original text and a reply to the original text that are extracted from the corpus environment, and therefore a correlation between a first feature and a second feature is obtained.

FIG. 4 is a schematic structural diagram of an implementation manner of an apparatus for automatically replying to information according to the present disclosure. The apparatus for automatically replying to information in this implementation manner includes a receiving module 410, a feature acquiring module 420, a match calculating module 430, and a selecting module 440. The feature acquiring module 420 includes a quick retrieving unit 421 and a feature acquiring unit 422.

The receiving module 410 is configured to receive information to be replied to. The receiving module 410 sends, to the feature acquiring module 420, the information to be replied to.

The feature acquiring module 420 is configured to acquire a keyword of the information to be replied to, as a first feature, and acquire a keyword of a pending reply in a pending reply set as a second feature.

The quick retrieving unit 421 is configured to quickly retrieve replies in a reply database to obtain the pending reply set.

For example, a user may receive, using QQ™, SMS, WeChat™, and the like, information to be replied to. When the information to be replied to that is received by the user is “My dissertation has been published in ACL 2012”, keywords “dissertation”, “published”, and the like of the information to be replied to are acquired as first features.

Replies may be prestored in the reply database. However, because a quantity of replies in the reply database is huge, after the user receives the information to be replied to, the quick retrieving unit 421 quickly retrieves the replies in the reply database using a locality sensitive hashing (LSH) or inverted indexing technology or the like to obtain a small pending reply set.

The quick retrieving unit 421 sends the pending reply set to the feature acquiring unit 422.

The feature acquiring unit 422 is configured to receive the pending reply set, and acquire the keyword of the pending reply in the pending reply set as the second feature.

For example, the feature acquiring unit 422 selects a pending reply from the pending reply set, and extracts a feature of the pending reply as the second feature. For example, if the selected pending reply is “Heartiest congratulations to you”, the extracted second features are “heartiest” and “congratulations”. Therefore, in this case, an association set of the first features and the second features is {(dissertation, heartiest), (dissertation, congratulations), (published, heartiest), and (published, congratulations)}.

The feature acquiring module 420 sends the first feature and the second feature to the match calculating module 430.

The match calculating module 430 is configured to receive the first feature and the second feature, and calculate, according to a correlation between the first feature and the second feature, a match between the information to be replied to and the pending reply, until matches between the information to be replied to and all pending replies are obtained.

For example, using the apparatus for acquiring a feature correlation shown in FIG. 3, a correlation between a first feature and a second feature may be obtained in advance through multiple training s according to an original text and a reply to the original text that are acquired from a corpus environment, where the corpus environment includes a microblog, a forum, and a post bar. It is understandable that the apparatus for acquiring a feature correlation may be an independent discrete apparatus, or may be integrated with the apparatus for automatically replying to information. Therefore, the match calculating module 430 may obtain a correlation between the first feature “dissertation” and the second feature “heartiest”, a correlation between the first feature “dissertation” and the second feature “congratulations”, a correlation between the first feature “published” and the second feature “heartiest”, and a correlation between the first feature “published” and the second feature “congratulations” in the association set of the first features and the second features. The match between the information to be replied to and the pending reply is calculated according to the correlation between the first feature and the second feature. The match between the information to be replied to and the pending reply is calculated according to

$$P = {\sum }_{i ∈ N} {a}_{i} {x}_{i} ,$$

where P is the match, N is the association set of the first feature and the second feature, i is an element in N, aᵢ is a weight, and xᵢ is a correlation between elements in the association set of the first feature and the second feature. For example, it may be assumed that the match between the information to be replied to and the pending reply is equal to the correlation between the first feature “dissertation” and the second feature “heartiest”*a first weight+the correlation between the first feature “dissertation” and the second feature “congratulations”*a second weight+the correlation between the first feature “published” and the second feature “heartiest”*a third weight+the correlation between the first feature “published” and the second feature “congratulations”*a fourth weight. Certainly, in other implementation manners, the match between the information to be replied to and the pending reply may also be used using other functions, which are not illustrated exhaustively herein.

The match calculating module 430 sends the matches to the selecting module 440.

The selecting module 440 is configured to receive the match, and select a best matched pending reply as a reply to the information to be replied to, to implement an automatic reply to the information to be replied to.

For example, the selecting module 440 sorts the matches between the information to be replied to and all pending replies, and selects the best matched pending reply as the reply to the information to be replied to, so that an automatic reply to the information to be replied to is implemented.

According to the foregoing solution, a match between information to be replied to and a pending reply can be calculated according to a correlation between a first feature and a second feature, so that a best matched pending reply is selected as a reply to the information to be replied to, and therefore user reply efficiency can be improved.

FIG. 5 is a schematic structural diagram of an implementation manner of a server according to the present disclosure. The server in this implementation manner includes an input device 510, a processor 520, an output device 530, a read-only memory 540, a random access memory 550, and a bus 560.

The input device 510 may input data using any one of a network technology, a Universal Serial Bus (USB) technology, a Universal Asynchronous Receiver/Transmitter (UART) technology, a General Packet Radio Service (GPRS) technology, and a Bluetooth® technology.

The processor 520 controls an operation of the server. The processor 520 may also be called a Central Processing Unit (CPU). The processor 520 may be an integrated circuit chip, and has a signal processing capability. The processor 520 may also be a general purpose processor, a digital signal processor (DSP), an application-specific integrated circuit (ASIC), a field programmable gate array (FPGA) or any other programmable logic device, a discrete gate or a transistor logic device, or a discrete hardware component. The general purpose processor may be a microprocessor or the processor may be any conventional processor and the like.

The output device 530 may outputdata using any one of the network technology, the USB technology, the UART technology, the General Packet Radio Service technology, and the Bluetooth™ technology.

The memory may include a read-only memory 540 and a random access memory 550, and provides an instruction and data to the processor 520. A part of the memory may further include a non-volatile random access memory (NVRAM).

Components of the server are coupled together using the bus 560, where in addition to a data bus, the bus 560 includes a power bus, a control bus, and a status signal bus. However, for clear description, various types of buses in the figure are marked as the bus 560.

The memory stores the following elements: an executable module or a data structure, or a subset thereof, or an extended set thereof operation instructions, including various operation instructions, used to implement various operations, and an operating system, including various system programs, used to implement various basic services and process hardware-based tasks.

In this embodiment of the present disclosure, by invoking an operation instruction stored in the memory (the operation instruction may be stored in the operating system), the processor 520 performs the following operations the processor 520 acquires, from a corpus environment, an original text and an eligible reply to the original text, where the corpus environment includes a microblog, a forum, and a post bar, and the eligible reply is a reply complying with a set condition, the processor 520 acquires a keyword of the original text as a first feature, and acquires a keyword of the eligible reply as a second feature, and the processor 520 trains a neural network model using the first feature and the second feature, to obtain a correlation between the first feature and the second feature.

In an embodiment, the processor 520 is configured to acquire, from the corpus environment, the original text and a reply to the original text, and clean the reply to the original text according to the set condition to obtain the eligible reply to the original text, where the set condition includes that a count of words exceeds 5, and that there is no attachment, and that the reply is within the first one hundred replies sorted in reply order.

According to the foregoing solution, a reply database can be obtained from a corpus environment, and a training is performed using an original text and a reply to the original text that are extracted from the corpus environment, and therefore a correlation between a first feature and a second feature is obtained.

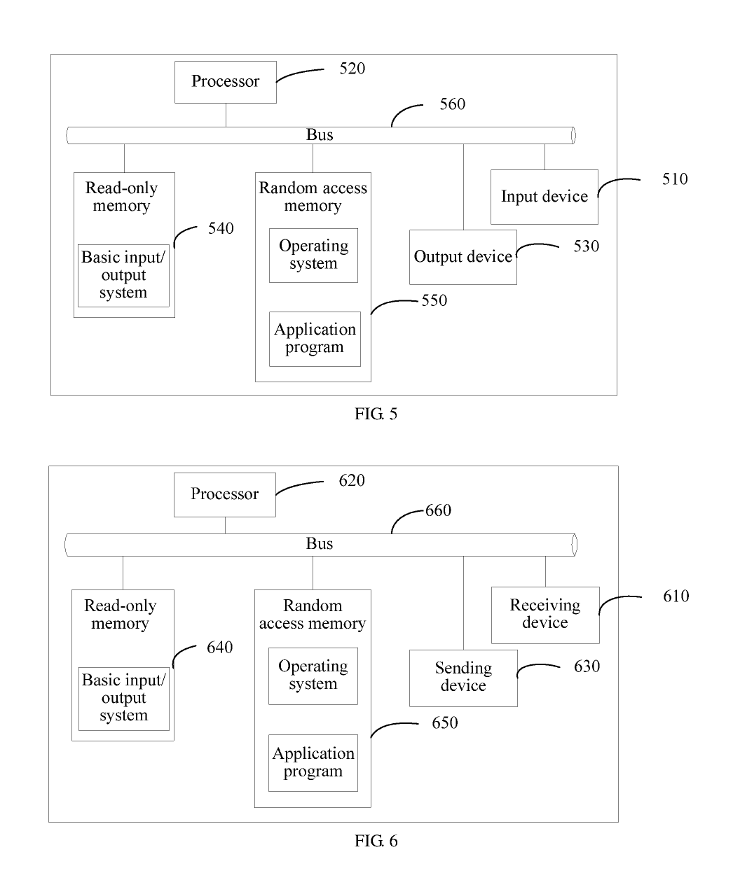

FIG. 6 is a schematic structural diagram of another implementation manner of a terminal according to the present disclosure. The terminal in this implementation manner includes a receiver 610, a processor 620, a transmitter 630, a read-only memory 640, a random access memory 650, and a bus 660.

The receiver 610 may receive information to be replied to that is received by application software such as QQ™, SMS, and, WeChat™.

The processor 620 controls an operation of the terminal. The processor 620 may also be called a CPU. The processor 620 may be an integrated circuit chip, and has a signal processing capability. The processor 620 may be a general purpose processor, a DSP, an ASIC, a FPGA or any other programmable logic device, a discrete gate or a transistor logic device, or a discrete hardware component. The general purpose processor may be a microprocessor or the processor may be any conventional processor and the like.

The transmitter 630 is configured to send reply information.

The memory may include a read-only memory 640 and a random access memory 650, and provides an instruction and data to the processor 620. A part of the memory may further include a NVRAM.

Components of the terminal are coupled together using the bus 660, where in addition to a data bus, the bus 660 includes a power bus, a control bus, and a status signal bus. However, for clear description, various types of buses in the figure are marked as the bus 660.

The memory stores the following elements: an executable module or a data structure, or a subset thereof, or an extended set thereof operation instructions, including various operation instructions, used to implement various operations, and an operating system, including various system programs, used to implement various basic services and process hardware-based tasks.

In this embodiment of the present disclosure, by invoking an operation instruction stored in the memory (the operation instruction may be stored in the operating system), the processor 620 acquires a keyword of information to be replied to, as a first feature, and acquires a keyword of a pending reply in a pending reply set as a second feature, calculates, according to a correlation between the first feature and the second feature, a match between the information to be replied to and the pending reply, where the correlation between the first feature and the second feature is obtained through multiple trainings according to an original text and a reply to the original text that are acquired from a corpus environment, where the corpus environment includes a microblog, a forum, and a post bar, and selects a best matched pending reply as reply information to the information to be replied to, to implement an automatic reply to the information to be replied to.

In an embodiment, the processor 620 acquires, from the corpus environment, the original text and an eligible reply to the original text, where the corpus environment includes a microblog, a forum, and a post bar, and the eligible reply is a reply complying with a set condition, acquires a keyword of the original text as the first feature, and acquires a keyword of the eligible reply as the second feature, and trains a neural network model using the first feature and the second feature, to obtain the correlation between the first feature and the second feature.

In an embodiment, the processor 620 performs customized processing on the best matched pending reply to obtain a customized reply.

In an embodiment, the processor 620 quickly retrieves replies in a reply database to obtain the pending reply set, and acquires the keyword of the pending reply in the pending reply set as the second feature.

In an embodiment, the processor 620 is configured to calculate, according to

$$P = {\sum }_{i ∈ N} {a}_{i} {x}_{i} ,$$

the match between the information to be replied to and the pending reply, where P is the match, N is an association set of the first feature and the second feature, i is an element in N, aᵢ is a weight, and xᵢ is the correlation between the first feature and the second feature.

According to the foregoing solution, a match between information to be replied to and a pending reply can be calculated according to a correlation between a first feature and a second feature, so that a best matched pending reply is selected as a reply to the information to be replied to, and therefore user reply efficiency can be improved.

In the several implementation manners provided in the present disclosure, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the implementation manners.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or some of the technical solutions may be implemented in the form of a software product. The software product is stored in a storage medium and includes several instructions for instructing a computer device (which may be a personal computer, a server, or a network device) or a processor (processor) to perform all or some of the steps of the methods described in the embodiments of the present disclosure. The foregoing storage medium includes any medium that can store program code, such as a USB flash drive, a removable hard disk, a read-only memory (ROM), a random access memory (RAM), a magnetic disk, or an optical disc.

What is claimed is:

1. A method for acquiring a feature correlation, comprising the following steps:
acquiring, from a corpus environment, an original text and an eligible reply to the original text, wherein the corpus environment comprises at least one of a microblog, a forum, and a post bar, and wherein the eligible reply is a reply complying with a set condition;
acquiring a keyword of the original text as a first feature;
acquiring a keyword of the eligible reply as a second feature; and
training a neural network model using the first feature and the second feature to obtain a correlation between the first feature and the second feature.

2. The method according to claim 1, wherein acquiring, from a corpus environment, an original text and an eligible reply to the original text, comprises:
acquiring, from the corpus environment, the original text and a reply to the original text; and
cleaning the reply to the original text according to the set condition to obtain the eligible reply to the original text, wherein the set condition comprises that a count of words exceeds 5, that there be no attachment, and that the reply is within the first one hundred replies sorted in reply order.

3. An apparatus for acquiring a feature correlation, comprising:
a receiver configured to acquire, from a corpus environment, an original text and an eligible reply to the original text, wherein the corpus environment comprises at least one of a microblog, a forum, and a post bar, and wherein the eligible reply is a reply complying with a set condition; and
a processor coupled to the receiver and configured to:
acquire a keyword of the original text as a first feature;
acquire a keyword of the eligible reply as a second feature; and
train a neural network model using the first feature and the second feature to obtain a correlation between the first feature and the second feature.

4. The apparatus according to claim 3, wherein the receiver is further configured to acquire, from the corpus environment, the original text and a reply to the original text, and wherein the processor is further configured to clean the reply to the original text according to the set condition to obtain the eligible reply to the original text, wherein the set condition comprises that a count of words exceeds 5, that there be no attachment, and that the reply is within the first one hundred replies sorted in reply order.

5. A method for automatically replying to information, comprising:
receiving information to be replied to;
acquiring a keyword of the information to be replied to as a first feature;
acquiring a keyword of a pending reply in a pending reply set as a second feature;
calculating, according to a correlation between the first feature and the second feature, a match between the information to be replied to and the pending reply, wherein the correlation between the first feature and the second feature is obtained through multiple trainings according to an original text and a reply to the original text that are acquired from a corpus environment, wherein the corpus environment comprises at least one of a microblog, a forum, and a post bar;
repeating the steps of acquiring a first feature, acquiring a second feature, and calculating a match, until matches between the information to be replied to and all pending replies are obtained; and
selecting a best matched pending reply as a reply to the information to implement an automatic reply to the information to be replied to.

6. The method according to claim 5, wherein the method further comprises:
acquiring, from the corpus environment, the original text and an eligible reply to the original text, and wherein the eligible reply is a reply complying with a set condition; and
training a neural network model using the first feature and the second feature to obtain the correlation between the first feature and the second feature.

7. The method according to claim 5, wherein after selecting the best matched pending reply as the reply to the information, the method further comprises performing customized processing on the best matched pending reply to obtain a customized reply.

8. The method according to claim 5, wherein acquiring the keyword of the pending reply in the pending reply set as the second feature comprises quickly retrieving replies in a reply database to obtain the pending reply set.

9. The method according to claim 5, wherein calculating, according to the correlation between the first feature and the second feature, the match between the information to be replied to and the pending reply, comprises calculating, according to
$$P = {\sum }_{i ∈ N} {a}_{i} {x}_{i} ,$$
the match between the information to be replied to and the pending reply, wherein P is the match, N is an association set of the first feature and the second feature, i is an element in N, aᵢ is a weight, and xᵢ is the correlation between the first feature and the second feature.

10. An apparatus for automatically replying to information, comprising:
a receiver configured to receive information to be replied to;
a processor coupled to the receiver and configured to:
acquire a keyword of the information to be replied to as a first feature;
acquire a keyword of a pending reply in a pending reply set as a second feature;
calculate, according to a correlation between the first feature and the second feature, a match between the information to be replied to and the pending reply until matches between the information to be replied to and all pending replies are obtained, wherein the correlation between the first feature and the second feature is obtained through multiple trainings according to an original text and a reply to the original text that are acquired from a corpus environment, wherein the corpus environment comprises at least one of a microblog, a forum, and a post bar, wherein the match calculating module sends the matches to the selecting module; and
select a best matched pending reply as a reply to the information to implement an automatic reply to the information to be replied to.

11. The apparatus according to claim 10, wherein the receiver is further configured to acquire, from the corpus environment, the original text and an eligible reply to the original text, and wherein the processor is furtherconfigured to train a neural network model using the first feature and the second feature, to obtain the correlation between the first feature and the second feature.

12. The apparatus according to claim 10, wherein the processor is further configured perform customized processing on the best matched pending reply to obtain a customized reply.

13. The apparatus according to claim 10, wherein the processor is further configured to quickly retrieve replies in a reply database to obtain the pending reply set.

14. The apparatus according to claim 10, wherein the processor is further configured to calculate, according to
$$P = {\sum }_{i ∈ N} {a}_{i} {x}_{i} ,$$
the match between the information to be replied to and the pending reply, wherein P is the match, N is an association set of the first feature and the second feature, i is an element in N, aᵢ is a weight, and xᵢ is the correlation between the first feature and the second feature.
